(19) United States
(12) Patent Application Publication
(10) Pub. No.: US 2011/0288673 A1
(43) Pub. Date: Nov. 24, 2011

(54) Method for Machining Composite Components

(75) Inventors: Alois Mundt, Kempten (DE); Thomas Mattern, Rieden (DE); Wilhelm Kennerknecht, Immenstadt (DE)

(73) Assignee: LIEBHERR-VERZAHNTECHNIK GMBH, Kempten/Allgaeu (DE)

(21) Appl. No.: 13/109,638

(22) Filed: May 17, 2011

(30) Foreign Application Priority Data
May 19, 2010 (DE) 10 2010 021 016.1

(51) Int. Cl. G05B 19/423

(52) U.S. Cl. 700/104; 901/9

(57) ABSTRACT

The present disclosure relates to a method for machining composite components in a CNC controlled machining station. In accordance with the present disclosure, a machining tool is guided along a preset tool edge by means of a measuring system, wherein it simultaneously carries out the machining operation, while the CNC control program to control the machining tool is generated in accordance with the measured result. The present disclosure furthermore relates to an apparatus for the carrying out of the method.

### CROSS REFERENCE TO RELATED APPLICATION

This application claims priority to German Patent Application No. 10 2010 021 016.1, entitled “Method for Machining Composite Components”, filed May 19, 2010, which is hereby incorporated by reference in its entirety for all purposes.

### TECHNICAL FIELD

The present disclosure relates to a method for machining large composite components in a CNC (computer numerical control) controlled machining station.

### BACKGROUND AND SUMMARY

Large composite components of this type such as are the subject of the present disclosure, are e.g. the rotor blades for wind turbines. These rotor blades are manufactured in complex and/or expensive production steps, by hand to a large extent. The largest and most modern vanes are composed of adhesively bonded fiberglass and carbon fiber mats into which epoxy resin is injected under vacuum. This high-tech construction provides the required extraordinary stability and flexibility, but simultaneously keeps the vanes thin and light.

The method or manufacturing the rotor blades in principle comprises the following steps:

First, the tool mold comprising two heatable half-shells is acted on by a separation means. The half-shells of the tool mold are configured with fiberglass mats and further reinforcement material.

Subsequently, special tubes are inserted from which the mixture of epoxy resins, hardeners and additives should be supplied. The fiberglass mats and the inserted tubes are subsequently covered by a plastic film which provides an airtight covering for the total surface. In the following step, a vacuum is produced between the tool and the film. This vacuum sucks the liquid epoxy resin/hardener mixture through the tubes into the tool, whereby the fiberglass mats and the other reinforcement material is soaked with the epoxy resin, the hardener and the additive. After complete soaking of the reinforcement material, the rotor blade halves are hardened at approximately 70 to 120° C.

Once the respective half-shells have been prepared, the half-shells forming the blade halves of the rotor blade are adhesively bonded to one another. On the adhesive bonding of the two rotor blade halves, resin is pressed outwardly out of the adhesive seam. This excess has to be removed for the further completion. This is still done by hand in the production process. Due to the hazardous nature of the GFC dust or GFC particles which are created on the machining, the operators have to wear full protective clothing with face masks for occupational health and safety reasons. On the processing by hand, the excess of the connection seam has to be removed using an angle grinder (cutting wheel). The residues of the excess are subsequently ground off using a grinding wheel.

The attempt has already been made in the prior art to carry out the corresponding handwork required on the grinding off of the seam by workpieces using a machine.

A unit for the edge machining of large and complex aircraft parts is described in U.S. Pat. No. 5,407,415 A. A gantry unit having an arm is used here to which a machining head having a tool is mounted. The movement of the arm takes place in accordance with a preprogrammed path relative to a machining table. Since the tool is moved along the preprogrammed path, a complex teaching route is required, on the one hand, and a highly precisely reproducible position of the tool is a requirement for an exact workpiece machining, on the other hand.

A gantry unit comprising two work zones for machining hulls is described in U.S. Pat. No. 9,938,501 A. It is a question of the contour machining of a hull and of a boat deck as well as the tool provision for this task. On the other hand, a suction plant is provided for sucking off ground fiberglass particles. The machining tool is guided at a gantry here.

A device for the surface treatment of rotor blades for wind turbines is known from WO 2008/077844. It is already described here to move a grinding tool along the rotor using a gantry and in so doing to machine the surface segment-wise.

WO 2008/110899 describes a mobile machining unit for surface machining large components such as boats. Here, structured light is projected onto the surface by means of a projector, with the result being taken by means of two cameras. A precise 3D image of the surface is generated from the taken image by means of computer assistance and is used for the machining.

It is now the object of the present disclosure to provide a method for the automated machining of large, and above all complex composite components along an edge present at the workpiece.

This object is achieved in accordance with the present disclosure by a method wherein a machining tool is guided along a preset tool edge by a measuring system, wherein the machining tool simultaneously carries out the machining operation, while a CNC control program to control the machining tool is generated in accordance with the measured result.

Accordingly, the large composite component is machined in a CNC-controlled machining station. The machining tool is guided along a preset component edge by a measuring system. In so doing, it simultaneously carries out the machining operation. The CNC control program for controlling the machining tool is simultaneously generated in accordance with the measured result of the measuring system. In accordance with the present disclosure, a real-time contour detection is therefore provided in 3 dimensions so that the machining head can be guided together with the tool along the edge to be machined or at a precisely defined spacing from this edge, with the machining task being able to be carried out. This machining task is, for example, to remove a material excess such as results in the joining together of components. However, other machining tasks such as a subsequent grinding, a required drilling operation or cutting work can also be carried out using the machining tool while taking account of the method in accordance with the present disclosure.

Preferred embodiments of the present disclosure result from the subordinate claims dependent on the main claim.

The workpiece edge of the composite component is measured by a suitable measuring system which can comprise a laser triangulation sensor. The sensor is mounted on the machining head for this purpose and moves together with it in the direction of the machining movement. The sensor is in this respect mounted in front of the actual tool and determines the course of the workpiece edge briefly before the tool engagement. It should be appreciated that this measuring system is distinct from, and in addition to, the CNC measuring system forming the CNC control of the machining head.

The course of the edge is determined from the measured signal with the aid of the suitable computer control, that is, the CNC control, so that the machining head or the machining tool can be tracked simultaneously in the three spatial planes. The workpiece to be machined accordingly does not have to be especially aligned for the machining since the machining work is carried out in dependence on the tool edge present.

In accordance with a particularly advantageous embodiment of the present disclosure, the measured signal can be compared with stored data such as CAD data. The CNC machining program can thus be constantly adapted to the real contour during the machining. Certain irregularities in the tool edge can be compensated with reference to the specific data.

Safety zones can furthermore be installed by the comparison with stored data. If the deviations are too large, the machining process can be interrupted before lasting damage arises on the workpiece.

At the start of the machining cycle, at least one point is defined on the workpiece and input into the CNC control, also with a preset direction vector. Alternatively to this, however, two points can also be defined on the workpiece and be input into the CNC control system. Subsequently, the machining process orients itself automatically at the preset tool edge.

A further aspect of the present disclosure comprises the fact that the feed speed or the tool rotation speed of the optionally rotating tool can be updated with reference to specific marginal conditions by the picking up of motor current of the machining tools. Depending on the motor current, the feed speed can be increased here, for example with a low density of the material to be removed or the feed speed can be reduced with a very high material removal. An optimum machining time can thus be achieved without e.g. thermal damage to the workpiece being able to occur due to feed speeds which are too high and heat input associated therewith. At the same time, the wear state and abrasive state of the tool can thus be taken into account.

The machining head can advantageously be equipped with an automatic tool changing system in order to be able to substitute the respective tool suitable for the machining task.

The tool data and important information such as the spacing of the triangulation measuring system from the tool storage region can be stored in the machine control for this purpose.

The method in accordance with the present disclosure can advantageously be used not only in the manufacture of wind energy rotors, but also in the manufacture of boats, aircraft components or similar complex components.

Further features, details and advantages of the present disclosure will be explained in more detail with reference to an embodiment shown in the drawings.

### BRIEF DESCRIPTION OF THE FIGURES

FIG. 1 shows a schematic three-dimensional representation of a composite component to be machined in a machining station in accordance with the present disclosure.

FIG. 2 shows an oblique view of the detail of a machining head which serves to carry out the method in accordance with the present disclosure.

FIG. 3 shows a plan view of the machining head in accordance with FIG. 2.

FIG. 4 shows an example routine that may be implemented by code stored in non-transitory computer readable medium, for example.

### DETAILED DESCRIPTION

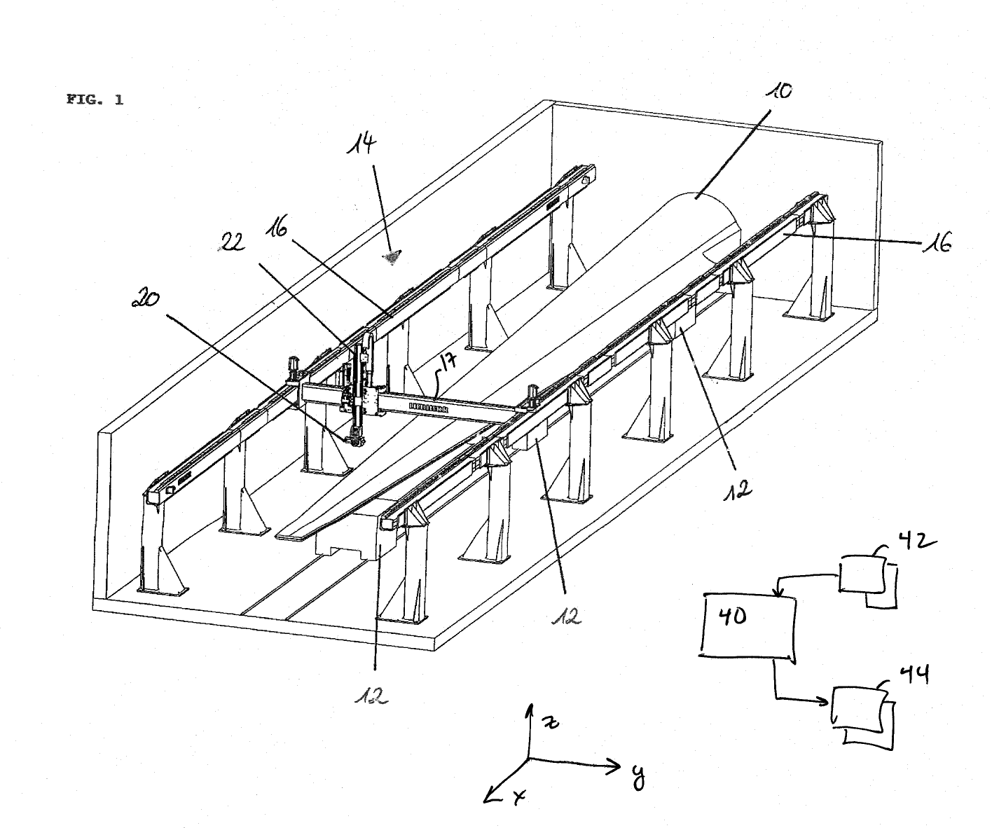

A rotor blade 10 as a composite component to be machined is shown in FIG. 1. In the rotor blade 10 shown here, the rotor blade halves have just been adhesively bonded to one another. Resin has escaped outwardly in a manner not shown in any more detail here from the adhesive seam so that an excess has arisen here which has to be removed for the further completion. For this purpose, the rotor blade 10 is clamped in a stationary manner on a multipart component holder 12. The clamped rotor blade 10 is surrounded in the hall by an area gantry 14 in which the gantry guides 16 are in each case arranged in a laterally elevated manner. A machining tool 20 is arranged at a lifting axle 22 in the area gantry 14.

A gantry controller 40 is shown receiving information from sensors 42 and sending control actuation signals to gantry actuators 44. For example, the sensors 42 may measure each of the corresponding positions of the gantry in the x-y-z planes (lateral, longitudinal, and vertical) of the gantry (e.g., along longitudinal guides 16, lateral guide 17, and vertical lifting axle 22). The gantry controller sends actuation signals to actuators 44, which may include respective motors or other actuators for each of the x, y, and z axis of the gantry. The gantry controller may also receive information from sensors mounted on the machining head 20, such as from measuring system 28 as described below. As such, sensors 42 may include information from measuring system 28, where controller determines a desired position in the x, y and z axis in accordance with the shape of the blade 10 and measurements from the sensor system 28. The gantry controller may be programmed generally with a desired cutting path along the part 10, while the final position of the cutting tool is controlled by the CNC machining head 20 as described below. Thus, the machining head 20 with the arranged machining tool can be moved over the area gantry 14 along the composite component to be machined for machining the linear seam region.

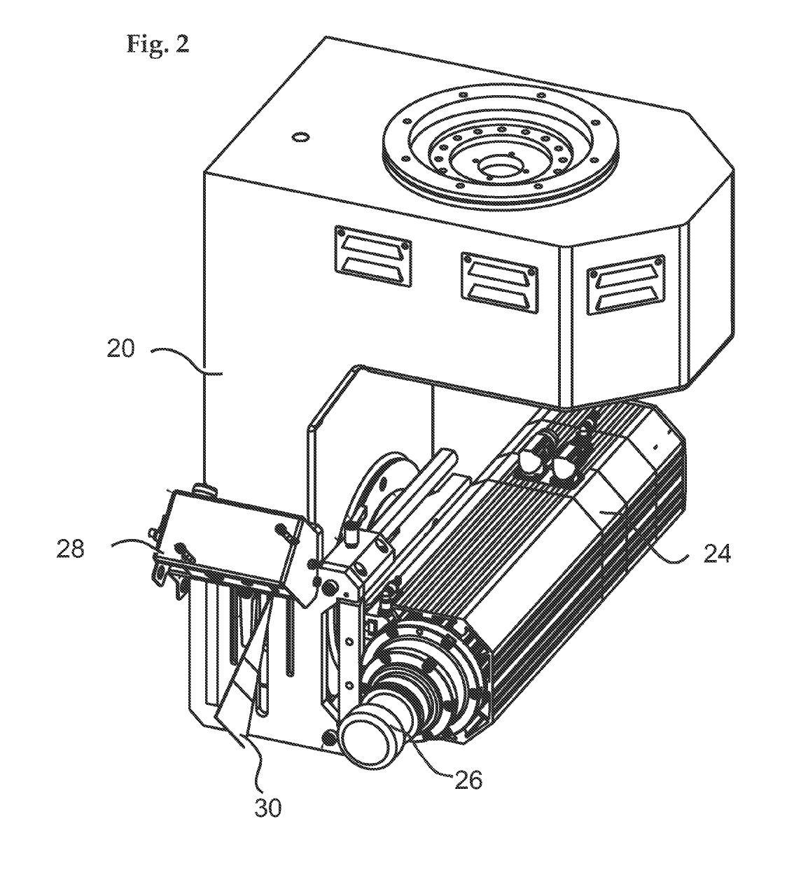

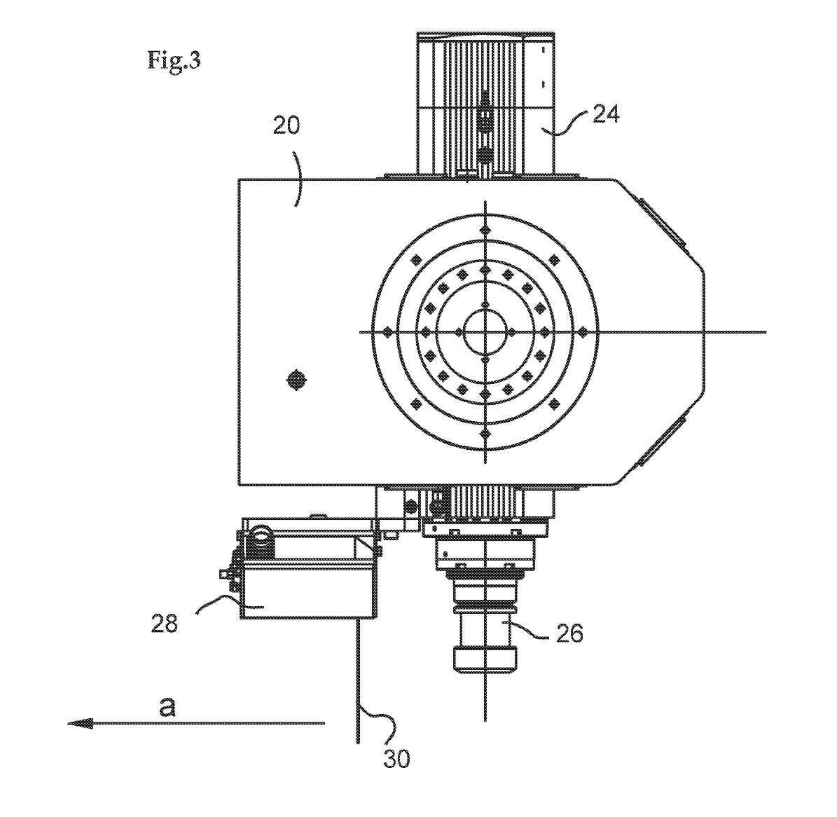

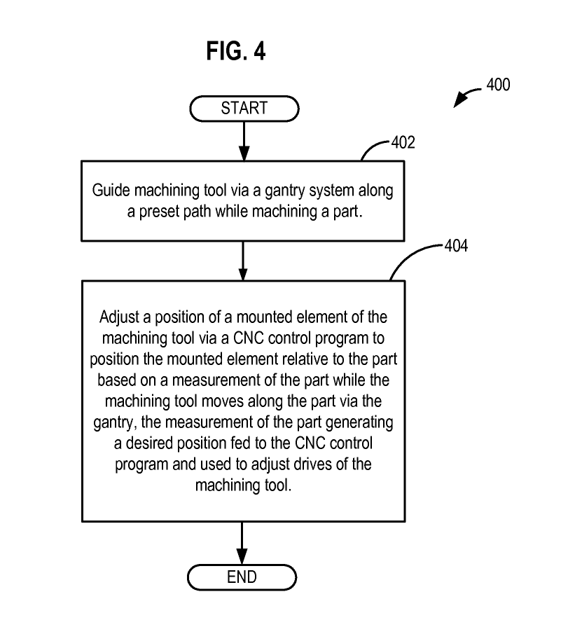

The machining head 20 is shown in more detail in FIGS. 2 and 3. As explained herein, the machining head 20 is itself a CNC controlled machine including a mounted element, shown herein as drive 24. The machining head 20 includes CNC controlled drives 36 and 38 to rotate the mounted element about respective first and second axes of rotation 32 and 34 based on sensor readings of the degree of rotation from sensors 52, as well as sensor system 28 as described herein via CNC controller 50. The desired position, and thus the control of the actuators 36 and 38, for example, is generated by on a desired position, the desired position in turn based on the data from the sensor system 28. Each of controllers 40 and 50 may include a processor and/or chip with instructions or other programming to carry out the various actions as described herein, such as with regard to FIG. 4, method 400, and blocks 402 and 404.

The drive 24 for the machining tool (the machining tool not shown here), is arranged in the machining head 20. A tool receiver 26 is set into rotation by means of the drive 24. The respective tool to be used can be received automatically on the tool receiver. If an excess has to be cut off at the composite component, the tool will be a cutting wheel not shown in any more detail here which is preferably laterally coated with diamonds and preferably has slits for the dust removal. However, any desired other rotating tools can also be received on the tool receiver 26. A measuring system 28, which in the present case comprises a laser triangulation sensor, is arranged on the machining head beside the tool. An optical measured signal 30 is output by means of it. The rotational speed, for example, of the drive 24 may be controlled by controller 50.

As can in particular be seen from FIG. 3, the measuring system 28 is arranged in front of the tool receiver 26 in the direction of movement such that the measured signal 30 covers the coordinate of the region to be machined before the tool comes into engagement. The sensor is therefore mounted close to the machining point. Since the movement control takes place in accordance with this sensor, the system stiffness of the machining system does not enter as a whole into the machining precision. Corresponding deviations are recognized by the sensor and immediately equalized by the three-dimensional spatial orientation of the machining head 20 via the CNC controller 50.

In the embodiment shown here, the machining head is arranged at an area gantry. In the same way, the machining head can, however, be fastened to any other desired travel unit, for example to a robot arm, wherein the robot arm can be moved on a floor travel rail or on a suspended rail along the composite component to be machined, or on a robot arm which is guided in a linear gantry or in another equivalent arrangement.

In an alternative embodiment variant, the machining head can also be arranged at a stationary robot when the component is correspondingly small so that the robot arm of the stationary robot reaches the regions of the composite component to be machined.

1. A method for machining composite components in a CNC controlled machining station, comprising:
guiding a machining tool along a preset tool edge based on a measured result from a measuring system, wherein the machining tool simultaneously carries out the machining operation while a CNC control program that controls the machining tool is generated in accordance with the measured result.

2. A method in accordance with claim 1, wherein the measured result of the measuring system is compared during the machining with stored CAD data and/or individually picked up measured points of the composite component so that the CNC control program is modified and updated in accordance with currently measured values of the measuring system with respect to the stored CAD data or measured points stored in advance, yet the machining process is interrupted on too large a difference of the currently measured values of the composite component from the stored CAD data or the measured points stored in advance.

3. A method in accordance with claim 2, wherein operating parameters of the tool are controlled in accordance with a current pick-up of a tool drive while taking account of technological marginal conditions in the machining of the composite component in order to avoid overheating of the composite component.

4. A method in accordance with claim 3, wherein the operating parameters of the tool include an advance speed and/or speed of rotation are regulated in dependence on tool wear, and wherein the technological conditions in the machining include a cutting speed.

5. A method in accordance with claim 1, wherein the composite component includes rotor blades for wind power rotors, boats, aircraft components or vehicle components.

6. A method in accordance with claim 1, wherein the machining tool is arranged together with the measuring system at one machining head.

7. A method in accordance with claim 6, wherein the machining tool is equipped with an automatic tool changing system.

8. A method in accordance with claim 6, wherein the machining head is guided over an area gantry or a linear gantry.

9. A method in accordance with claim 6, wherein the machining head is arranged at a robot arm, wherein the robot can be moved on a floor travel rail or a suspended rail along the composite component to be machined or is configured as a stationary robot.

10. A method in accordance with claim 1, wherein the measuring system includes a laser triangulation sensor.

11. A method for machining composite components in a CNC controlled machining station, the machining station having a machining head with a CNC position-controlled mounted machining component and a measuring system, comprising:
measuring an actual contour of composite rotor blade relative to the machining head while moving the machining head via a gantry along the composite rotor blade;
machining the composite component rotor blade in the machining station while the machining head moves along a preset edge, with position of the mounted machining component adjusted in real-time based on real-time three-dimensional feedback from the measuring system of the actual edge contour via CNC control.

12. The method of claim 11, wherein the machining head removes excess material from the edge, the excess material resulting from a joining together of a plurality of components to form the composite component.
